(19) United States
(12) Patent Application Publication
(10) Pub. No.: US 2009/0327712 A1
(43) Pub. Date: Dec. 31, 2009

(54) SYSTEM AND METHOD FOR VARIABLE ENCRYPTION

(76) Inventor: Amnon Sarig, Woodland Hills, CA (US)

Correspondence Address: Naomi Assia Law Offices;C/O Landon IP Inc., 1725 Jamieson Ave., Alexandria, VA, 22314, US

(21) Appl. No.: 12/164,069

(22) Filed: Jun. 29, 2008

(51) Int. Cl. H04L 9/00

(52) U.S. Cl. 713/165

(57) ABSTRACT

A method for variable encryption of a plurality of files. The method serves a plurality of subscribers. The method includes receiving a request from one of the plurality of subscribers to download at least one of the plurality of files and receiving authorization to download the at least one of the plurality of files. The method also includes accessing the at least one of the plurality of files, encrypting the at least one of the plurality of files and inserting a key into the encrypted at least one of the plurality of files. Finally, the method includes downloading the encrypted at least one of the plurality of files to the one of the plurality of subscribers, extracting the key and deciphering the encrypted at least one of the plurality of files, thereby making available decrypted at least one of the plurality of files to the one of the plurality of subscribers.

### FIELD OF THE INVENTION

The present invention generally relates to encryption methods, and more particularly to a method for variable encryption of text and multimedia files.

### BACKGROUND OF THE INVENTION

In US Pat. Applic. No. 20030212613, System and Method for Providing Access to Digital Goods Over Communications Networks, by the inventor of the present invention, a similar method is disclosed for a different application. It is a simple and self sustaining Digital Rights Management (DRM) implementation that has a date kill code.

A system, method and computer program product is disclosed that allows real-time, secure access to digital multimedia files over a communications network (e.g., the Internet) is provided. The system allows a user to receive large amounts of multimedia data without requiring a high bandwidth data path to an Internet server. The method and computer program product allow the user to employ a selection process from a hypertext data page to obtain and view/play the contents of specific sets of multimedia data which are stored in a storage device local to the user. The files on the local device are unusable without the instructions from the hypertext page. The present invention involves no change to standard WWW protocols, allows the user to interact in a regular-fashion with all other WWW servers and controls the multimedia server over a standard Internet connection.

FIG. 1 is schematic flow diagram of the prior art encryption process. Unencrypted information 141 is processed by a computer, or other means of encryption 110, according to a fixed encryption key 130. The output of means of encryption 110 is encrypted code 142.

Thus, it would be advantageous to provide a method for variable encryption.

### SUMMARY OF THE INVENTION

Accordingly, it is a principal object of the present invention to provide a method for variable encryption.

A method for is disclosed for variable encryption of a plurality of files. The method serves a plurality of subscribers. The method includes receiving a request from one of the plurality of subscribers to download at least one of the plurality of files and receiving authorization to download the at least one of the plurality of files. The method also includes accessing the at least one of the plurality of files, encrypting the at least one of the plurality of files and inserting a key into the encrypted at least one of the plurality of files. Finally, the method includes downloading the encrypted at least one of the plurality of files to the one of the plurality of subscribers, extracting the key and deciphering the encrypted at least one of the plurality of files, thereby making available decrypted at least one of the plurality of files to the one of the plurality of subscribers.

For every instantiation of the material to be encrypted, the encryption is regenerated and the encrypted output looks totally different, but all the information when decrypted is the same. As en exemplary application, the encrypted material is the line-by-line timeline of the sequential lines of a song.

For this example the method of the present invention solves a practical problem:

A proprietary Web site serves as a repository for synchronized timing to lyrics for millions of songs. The timing information is uploaded from the users' iphones, with unencrypted timing. This timing information is a major Intellectual Property (IP). Therefore one cannot have a fixed formula for encryption, as it would be enough to have one file “before” and “after” to discover the encryption formula.

Therefore the present invention uses a “lock” or encryption formula that changes all the time, and directs the decipher program to look for the hint of the locking mechanism IN the code. Thus, if one has a padlock and a key, the padlock is turned around in space in all directions. That's ok, because the key needs to go in with the same orientation relative to the lock and turns accordingly with lock.

In a simple example, the cipher (encoded material) and the decipher (decoding algorithm) are set to look for a ‘map’ of the key in the code at the same physical position in the encrypted information.

For example: if it is desired to encode the following string of numbers:
Digit position: #1 #2 #3 #4 #5 #6 #7 #8 #9
Digit: 1 2 3 4 5 6 7 8 9

Assume the algorithm was pre-arranged so that digit POSITIONS #3, #5 and #7 in the string of digits in the encrypted data is the ‘key.’

The ciphering program will create a random 3 digit key. The key can have 1000 combinations (“000” to “999”). For each instantiation of encryption of the SAME string, another random number is chosen from the 1000 combinations available. For the metaphor of a physical lock it is an equivalent of having 1000 ways to orient the “lock” in space.

In the simplest implementation of the method, for example, XOR the original information, digits 1-9, with the random key selected from the 1000 possible keys. Call that ‘combination’ XYZ (the numerical number for the sample). There are 1000 combinations because there are now 3 digital positions: X, Y and Z, where 10³=1,000.

In computer programming, a bitwise operation operates on one or two bit patterns or binary numerals at the level of their individual bits. A bitwise exclusive or takes two bit patterns of equal length and performs the logical XOR operation on each pair of corresponding bits. The result in each position is 1 if the two bits are different, and 0 if they are the same. For example:

$$\begin{matrix} 0101 \\ XOR \underline{0101} \\ = 0000\end{matrix} \begin{matrix} 0101 \\ XOR \underline{0011} \\ = 0110\end{matrix}$$

In the first example XORing a number with itself results in 0's.

After the XOR, the number will look completely different, and there are 1000 possible ways to make it look different.

For example, if the string received is: 847364027

Digit position: #1 #2 K #3 #4 E #5 #6 Y #7 #8 #9

inserting KEY in the string gives: 8 4 X 7 3 Y 6 4 Z 0 2 7

The resulting string of numbers, one of the 1000 possible FOR THE SAME INFORMATION, is then sent to the client computer. Thus, first X is removed in the 3^{rd} position then Y in the 5^{th} position. When Y is removed, then Z is in the 7^{th} position and Z is removed.

Now the original string is restored as follows:

Digit position: #1 #2 #3 #4 #5 #6 #7 #8 #9

inserting KEY in the string gives: 8 4 7 3 6 4 0 2 7

and the key, XYZ is known.

Thus, the client computer extracts the XYZ number, as it knows from the algorithm that the key is hidden in positions 3, 5 and 7. Once the key is available, XORing will give the original string of numbers and the deciphering is complete. The deciphering is undone by XORing, because the XORing turns encryption information to leading zeroes for each deciphered value.

This is a trivial example. Many variations on the same idea of hiding the key IN the data are available. There are unlimited ways to create mathematical and logical functions to use the same principle.

Here is another example, without using an actual KEY in the data. For this example all one needs to know is that positions 3, 4, 5, 6, just as an illustration, are a RANDOM NUMBER that has NOTHING TO DO with the original data.

The decipher key will simply ignore these “noise” positions and put back the original string without them. This method has 10,000 combinations, but with added positions it could be greater, and therefore is not limited to 10,000. There 10,000 because there are now 4 digital positions: 3, 4, 5 and 6, where 10⁴=10,000.

Combining the two examples creates an even more complex method: the ciphering and deciphering algorithm can agree that the first digit represents a method of encryption used for that specific line of content. There will be 10 mathematical formulas to use, as pre-set in the algorithm.

Before each time it is transmitted, the same information will be randomly encrypted with a different formula.

In a very simple example of this combination of the methods:

Assume the first digit represents how many digits are ‘noise’ introduce into the string, and it was agreed that the noise will start always on position 4 and will last for as many digits as indicated by the first digit (4 in this example).

### And so on.

As long as the cipher and the decipher use the same mathematical and logical algorithm for ‘hiding the key in plain sight within the data encrypted,’ the exact same information can look completely different each time it is re-encrypted and re-sent.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic flow diagram of the prior art encryption process;

FIG. 2 shows a schematic flow diagram of the encryption process, constructed in accordance with an embodiment of the present invention;

FIG. 3 shows 3 different samples of encrypted timing for lyrics, constructed in accordance with an embodiment of the present invention; and

FIG. 4 is an exemplary flow chart of the method for variable encryption, constructed in accordance with an embodiment of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

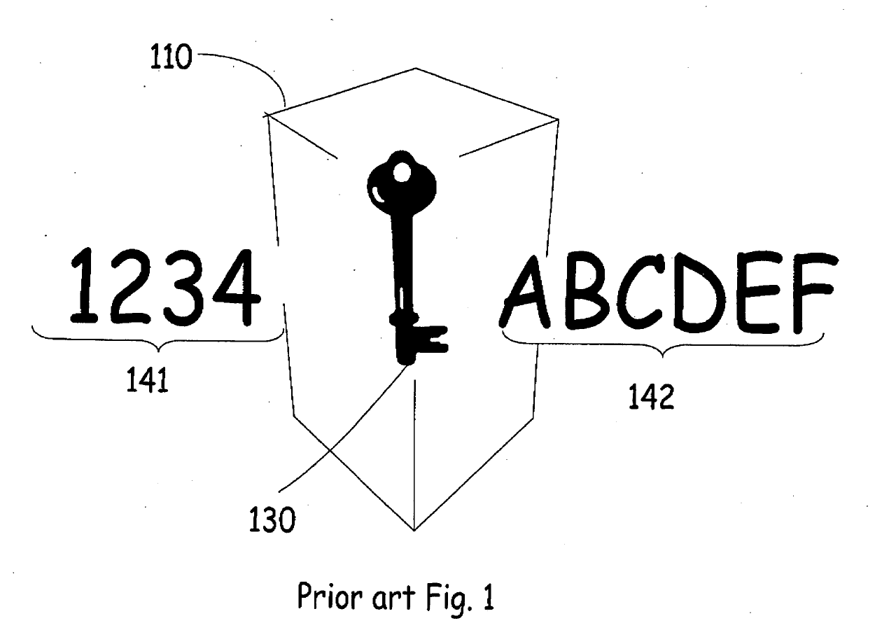

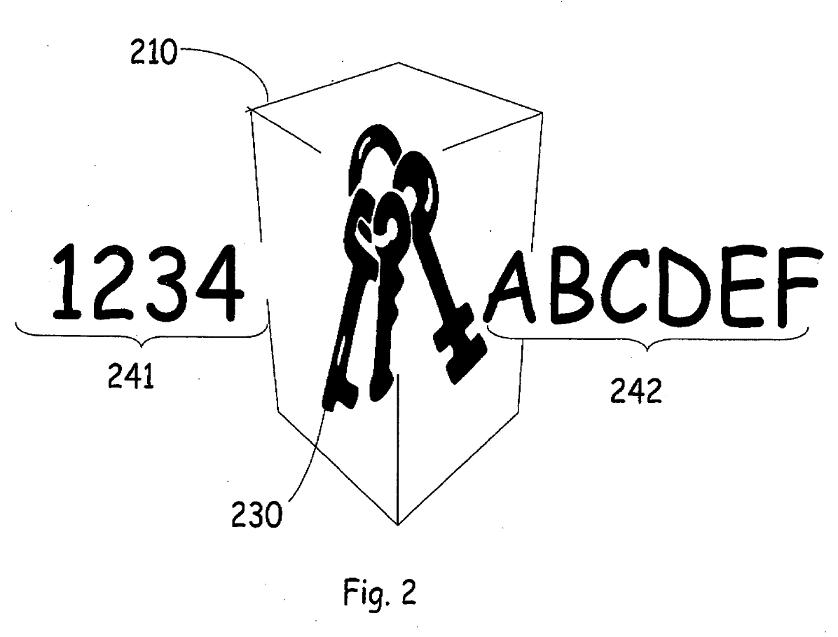

FIG. 2 shows a schematic flow diagram of the encryption process, constructed in accordance with an embodiment of the present invention. FIG. 1 is schematic flow diagram of the prior art encryption process. Unencrypted information 141 is processed by a computer, or other means of encryption 110, according to a fixed encryption key 130. The output of means of encryption 110 is encrypted code 142.

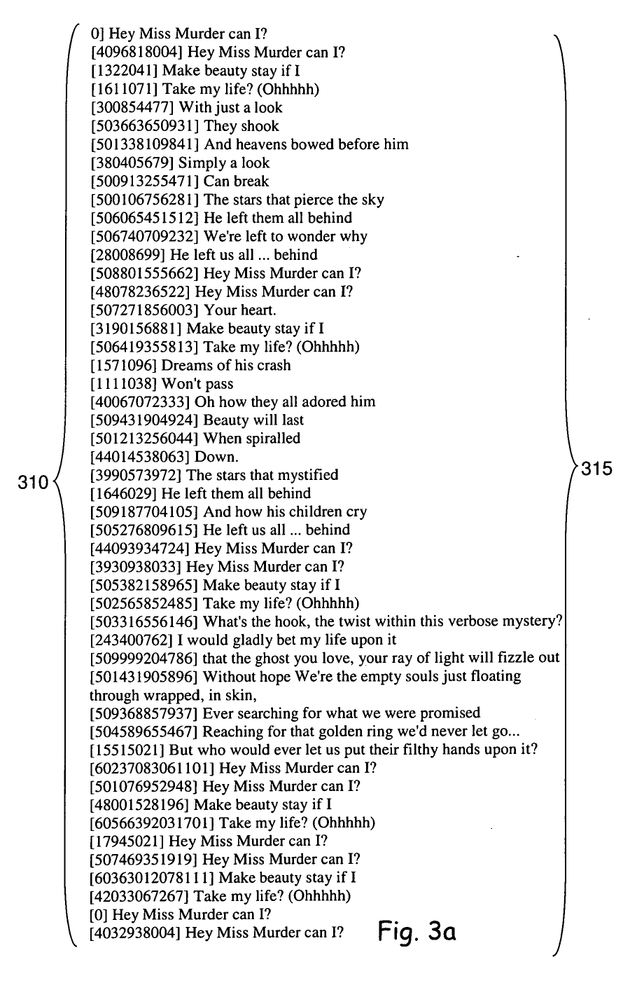

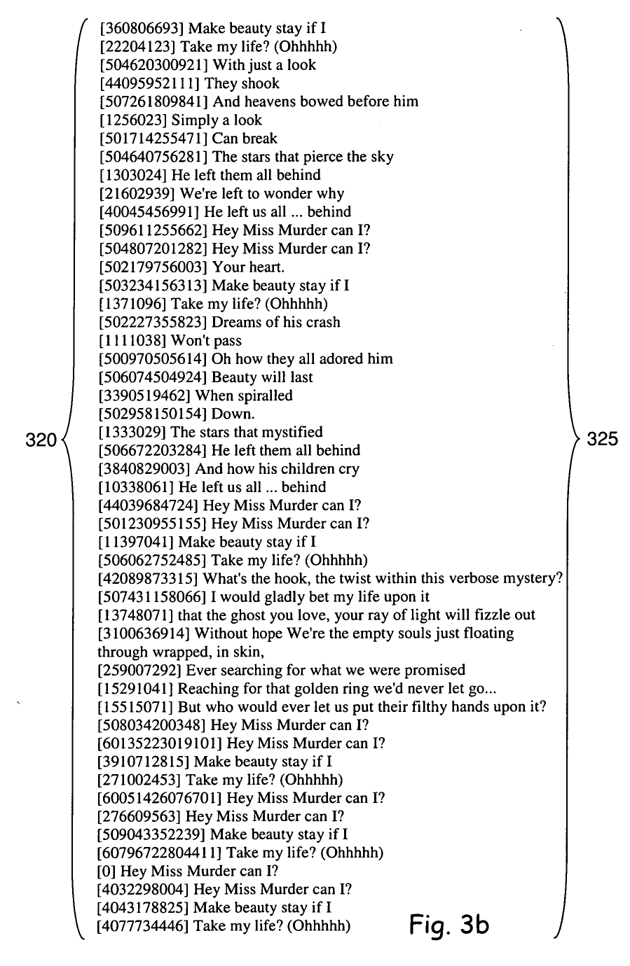

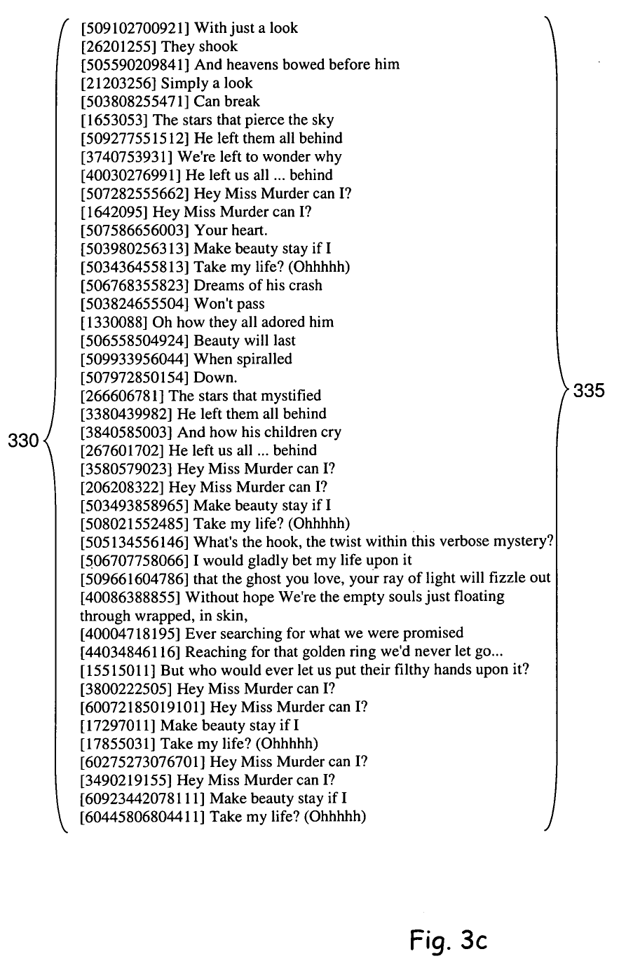

FIG. 3 shows 3 different samples of encrypted timing for lyrics, constructed in accordance with an embodiment of the present invention. In each of FIGS. 3a, 3b and 3c the complete lyrics are listed line-by-line for a song 315, 325 and 335 respectively. To the left of each set of lyrics 315, 325 and 335, the respective encoded timing data 310, 320 and 330 is also listed. In particular note that each set of encoded timing data 310, 320 and 330 is completely different.

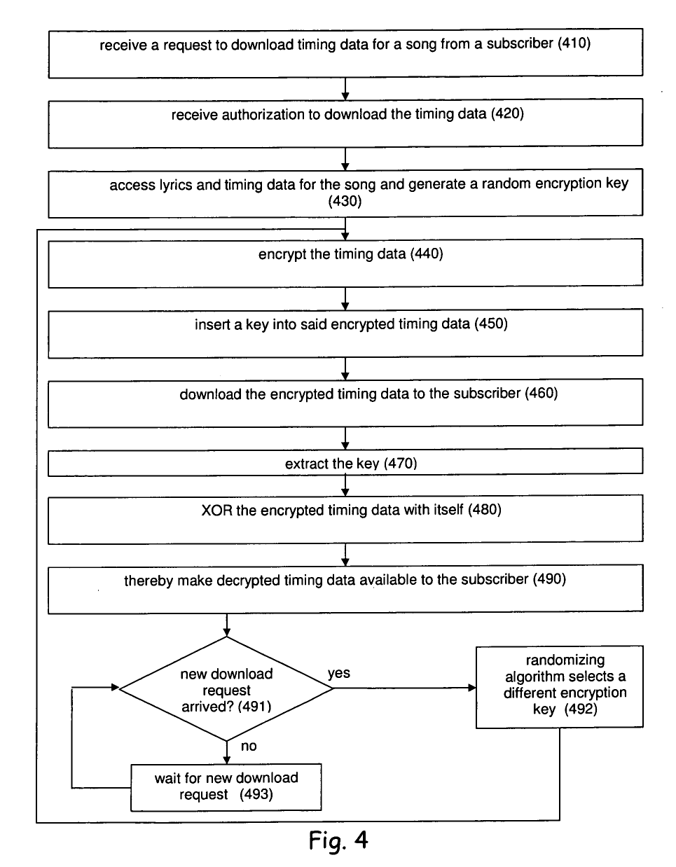

FIG. 4 is a flow chart of the method for variable encryption, constructed in accordance with an embodiment of the present invention. A method is provided for variable encryption of text and multimedia files. As one example of the method, a proprietary Website may receive a request to download timing data for a song from a subscriber 410. In the next steps authorization is received to download the timing data 420 and the lyrics and timing data are accessed from an online database for the song 430. Then the timing data is encrypted 440 and a key is inserted into the encrypted timing data 450. Subsequently the encrypted timing data is download to the customer 460, the key is extracted 470 and the encrypted timing data is XORed with itself 480, thereby making the decrypted timing data available to the customer 490.

If a new download request is received at the proprietary Website from a subscriber 491, a randomizing algorithm selects a different encryption key 492 and the process repeats from step 440, and if not the system waits for a new download request 493.

Thus, XOR the encrypted data with the KEY, or implement any other mathematical linear formula on the encrypted data. The method includes any encryption where the decipher function is built into the encrypted data itself. XOR is only one example of a mathematical formulation applicable for encryption/decryption. ANY function that has a one-to-one transformation result can be applied. I.e., any function can be applied that has only has one result for each input value.

Besides XOR any other single-valued math function with one-to-one results can be used. For example Y=aX+b. As another example, Y=a[ABS(X²)]+b can be used, because as it only uses one arm of the parabola, as opposed to Y=aX²+b, which cannot be used, because it uses both arms of the parabola and therefore would have two encryption results for each input value.

Although the invention has been described with a certain degree of particularity, it should be understood that various changes can be made to it by those skilled in the art without departing from the spirit or scope of the invention as hereinafter claimed.

1. A method for variable encryption of a plurality of files, said method serving a plurality of subscribers, said method comprising:
receiving a request from one of said plurality of subscribers to download at least one of said plurality of files;
receiving authorization to download said at least one of said plurality of files;
accessing said at least one of said plurality of files;
encrypting said at least one of said plurality of files;
inserting a key into said encrypted at least one of said plurality of files;
downloading said encrypted at least one of said plurality of files to said one of said plurality of subscribers;
extracting said key; and
deciphering said encrypted at least one of said plurality of files,
thereby making available decrypted at least one of said plurality of files to said one of said plurality of subscribers.

2. The method of claim 1, where said deciphering said encrypted at least one of said plurality of files comprises XORing said encrypted at least one of said plurality of files with itself,
thereby making available decrypted at least one of said plurality of files to said one of said plurality of subscribers.

4. The method of claim 1, where said deciphering said encrypted at least one of said plurality of files comprises applying a linear function to said encrypted at least one of said plurality of files,
thereby making available decrypted at least one of said plurality of files to said one of said plurality of subscribers.

5. The method of claim 1, where said deciphering said encrypted at least one of said plurality of files comprises applying a single-valued non-linear function to said encrypted at least one of said plurality of files,
thereby making available decrypted at least one of said plurality of files to said one of said plurality of subscribers.

6. A method for variable encryption of timing data corresponding to the lyrics of songs, said method serving a plurality of subscribers, and said method comprising:
Receiving a request to download timing data for a song from one of said plurality of subscribers;
receiving authorization to download said timing data;
accessing lyrics and timing data for said song;
encrypting said timing data;
inserting a key into said encrypted timing data;
downloading said encrypted timing data to said one of said plurality of subscribers;
extracting said key; and
XORing said encrypted timing data with itself,
thereby making available decrypted timing data to said one of said plurality of subscribers.

7. A system for variable encryption of a plurality of files, said system serving a plurality of subscribers, and said system comprising:
means for receiving a request from a one of said plurality of subscribers to download at least one of said plurality of files;
means for receiving authorization to download said at least one of said plurality of files;
means for accessing said at least one of said plurality of files;
means for encrypting said at least one of said plurality of files;
means for inserting a key into said encrypted at least one of said plurality of files;
means for downloading said encrypted at least one of said plurality of files to said one of said plurality of subscribers;
means for extracting said key; and
means for deciphering said encrypted at least one of said plurality of files,
thereby making available decrypted at least one of said plurality of files to said one of said plurality of subscribers.
